(19) United States
(12) Patent Application Publication
(10) Pub. No.: US 2016/0048862 A1
(43) Pub. Date: Feb. 18, 2016

(54) NESTED MICRO-MARKETPLACES WITHIN AN ONLINE MARKETPLACE

(71) Applicant: Dane Glasgow, Los Altos, CA (US)

(72) Inventor: Dane Glasgow, Los Altos, CA (US)

(21) Appl. No.: 14/460,302

(22) Filed: Aug. 14, 2014

(51) Int. Cl. G06Q 30/02; G06Q 30/06

(52) U.S. Cl. CPC G06Q 30/0222; G06Q 30/0239; G06Q 30/0601

(57) ABSTRACT

Systems and methods are presented for nested micro-marketplaces in an online marketplace. In some embodiments, a method is presented that may include accessing a product listing for a product in the online marketplace placed by a seller. The method may also include accessing a first price in the product listing placed by the seller, the first price applicable to a first group of users associated with the online marketplace; accessing a second price in the product listing, the second price applicable to a second group of users associated with the online marketplace and being discounted from the first price for the second group due to a closeness affiliation with the seller of the product; and accessing an offer to purchase the product, the offer either originating from the first group and being offered at the first price, or originating from the second group and being offered at the second price.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2014, eBay Inc. All Rights Reserved.

### TECHNICAL FIELD

The subject matter disclosed herein generally relates to consumer transactions in a virtual marketplace. In some example embodiments, the present disclosures relate to systems and methods for nested micro-marketplaces within an online marketplace.

### BRIEF DESCRIPTION OF THE DRAWINGS

Some embodiments are illustrated by way of example and not limitation in the figures of the accompanying drawings.

FIG. 1 is a block diagram illustrating a network architecture suitable for facilitating nested micro-marketplaces within an online marketplace, according to some example embodiments.

FIG. 2 is block diagram illustrating a mobile device suitable for facilitating nested micro-marketplaces within an online marketplace, according to some example embodiments.

FIG. 3 is an illustration of a nested micro-marketplace, according to some example embodiments.

FIG. 4 is an illustration of an online marketplace with multiple micro-marketplaces, according to some example embodiments.

FIG. 5 is a diagram illustrating an example product listing utilizing micro-marketplaces, according to some example embodiments.

FIG. 6 is another diagram illustrating an example product listing utilizing micro-marketplaces, according to some example embodiments.

FIG. 7 is a flowchart illustrating example operations for utilizing micro-marketplaces, according to some example embodiments.

FIG. 8 is a block diagram illustrating components of a machine, according to some example embodiments, able to read instructions from a machine-readable medium and perform any one or more of the methodologies discussed herein.

### DETAILED DESCRIPTION

A merchant in an online marketplace may have preferences when selling items to customers. For example, like many people, the merchant may be willing to offer a discount on an item to family or close friends compared to selling that same item to the general public. As another example, the merchant may not need to cover the cost of shipping if selling to a neighbor nearby, and may be willing to discount an item to reduce or eliminate the cost of shipping for neighbors as compared to selling that same item to customers anywhere else in the United States. While these kinds of exchanges may occur naturally in an interpersonal or face-to-face setting, a merchant selling many merchandise items in an online marketplace that facilitates traffic from thousands or even millions of viewers would have great difficulty considering discounts for potential customers on a case-by-case basis. Therefore, it may be desirable to better facilitate the sale of items to multiple subgroups in an online marketplace setting.

Aspects of the present disclosure are presented for enabling nested micro-marketplaces within an online marketplace environment. As used herein, a micro-marketplace may refer to a group of individuals and/or entities that have at least a first commonality amongst each other. The micro-marketplace may be nested in the sense that the group comprising the micro-marketplace is also affiliated with a larger group of individuals and/or entities that have a second commonality amongst the entire larger group, while the other individuals and/or entities in the larger group but not part of the micro-marketplace do not possess or share the first commonality. In some example embodiments, a merchant may place a product for sale in an online marketplace. The merchant may set a first price for the product applicable to a first group within the online marketplace. The merchant may also set a second price for the same product applicable to a second group within the online marketplace, where the second price may be discounted from the first price due to the second group having some closeness affiliation with the merchant. In some example embodiments, the second group may be a subset of the first group. In some example embodiments, multiple nested micro-marketplaces may be specified by the merchant, where a second micro-marketplace is specified as a subgroup of a first micro-marketplace. The first and second micro-marketplaces would have different price listings or discounts for the same product. In some example embodiments, the micro-marketplaces can be enabled by the merchant in an auction context as well. These and other descriptions will be presented in more detail, below.

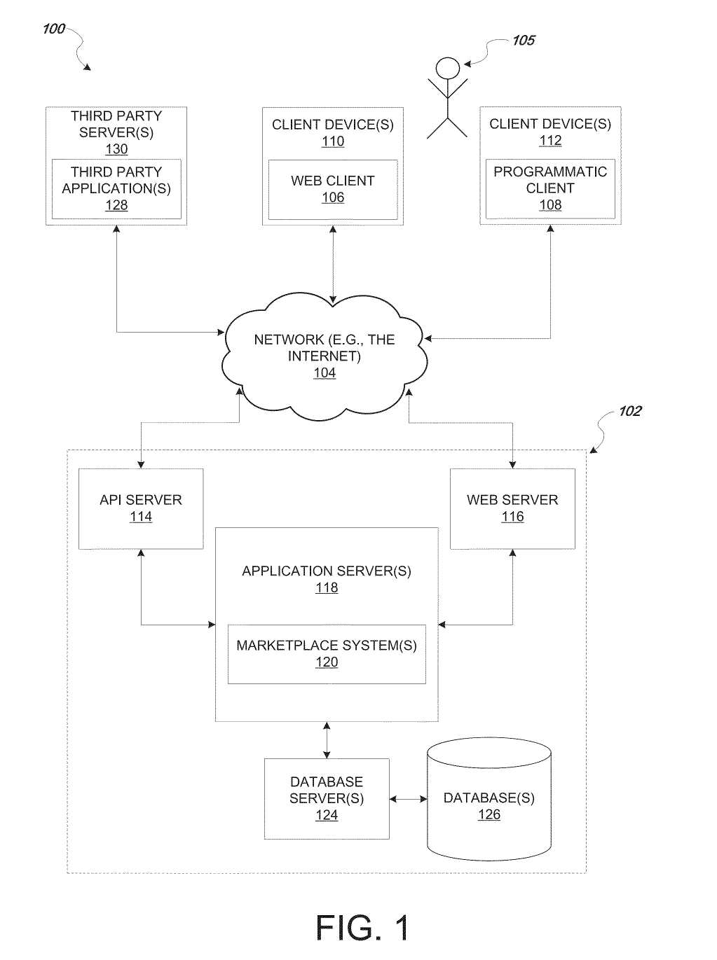

Referring to FIG. 1, a high-level client-server-based network architecture 100 is shown, according to some example embodiments. The network architecture 100 may include systems, applications, modules, and/or other means for utilizing aspects of the present disclosure, as may be apparent to those with skill in the art. For example, the network architecture 100 may include means for facilitating nested micro-marketplaces in an online marketplace environment, according to aspects of the present disclosure. Example means can include software stored in application server(s) 118 configured to access settings by a merchant or user 105 that specify different prices for different groups of individuals and/or entities for the same product. These settings can be incorporated into a product listing and displayed through software to potential customers via the network 104. In some example embodiments, a networked system 102 may facilitate network-based marketplace system(s) 120, providing server-side functionality via network 104 (e.g., the Internet or wide area network (WAN)) to one or more client devices 110 and 112. FIG. 1 illustrates, for example, a web client 106 (e.g., a browser, such as the Internet Explorer® browser developed by Microsoft®), and a programmatic client 108 executing on respective client devices 110 and 112. The network-based marketplace system(s) 120 may include a website or other central repository for storing and displaying the product listings including information based on the nested micro-marketplaces.

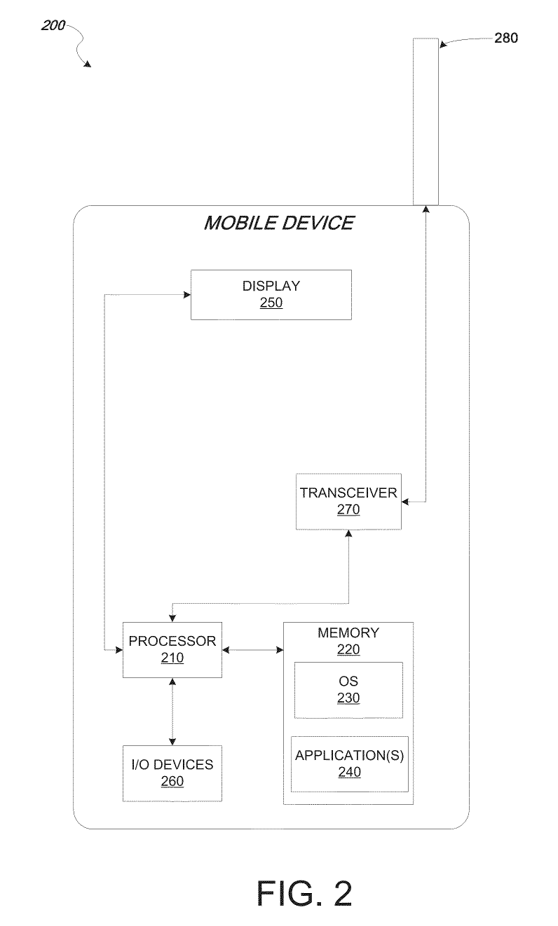

Examples of client devices 110 and 112 may include, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, handheld game systems, set-top boxes, or any other communication device that a user may utilize to access the networked system 102. Example client devices 110 and 112 may be consistent with the mobile device 200, described in FIG. 2 below. In some cases, the client devices 110 and 112 may be controlled by a merchant selling products online via the networked system 102. In other cases, the client devices 110 and 112 may be controlled by potential customers accessing the networked system 102 in order to shop online for products. In further embodiments, the client device 110 may comprise one or more of touch screens, accelerometers, gyroscopes, cameras, microphones, global positioning system (GPS) devices, and so forth. In some examples embodiments, the networked system 102 is a network-based marketplace that responds to requests for product listings, publishes publications comprising item listings of products available on the network-based marketplace, and manages payments for these marketplace transactions. The product listings may include an indication that the user 105 is a member of a micro-marketplace, and may receive some form of discount for the particular product if purchased. One or more users 105 may be a person, a machine, or other means of interacting with client devices 110 and 112. In embodiments, the user 105 is not part of the network architecture 100, but may interact with the network architecture 100 via client devices 110 and 112 or another means.

An application program interface (API) server 114 and a web server 116 may be coupled to, and provide programmatic and web interfaces respectively to, one or more application servers 118. The application servers 118 may host one or more marketplace systems 120, which may comprise one or more modules or applications and which may be embodied as hardware, software, firmware, or any combination thereof. The application servers 118 are, in turn, shown to be coupled to one or more database servers 124 that facilitate access to one or more information storage repositories or database(s) 126. In some example embodiments, the databases 126 are storage devices that store information to be posted (e.g., publications or listings, images of products, etc.) to the marketplace system(s) 120. The databases 126 may also store digital goods information in accordance with example embodiments.

The marketplace system(s) 120 may provide a number of marketplace functions and services to users 105 that access the networked system 102. For example, marketplace system(s) 120 may facilitate participation in nested micro-marketplaces in an online marketplace environment. While the marketplace system(s) 120 is shown in FIG. 1 to form part of the networked system 102, it will be appreciated that, in alternative embodiments, the marketplace system(s) 120 may form part of a payment service that is separate and distinct from the networked system 102.

Further, while the client-server-based network architecture 100 shown in FIG. 1 employs a client-server architecture, the present inventive subject matter is, of course, not limited to such an architecture, and may equally well find application in a distributed, or peer-to-peer, architecture system, for example. The various marketplace system(s) 120 may also be implemented as standalone software programs, which do not necessarily have networking capabilities.

The web client 106 accesses the various marketplace system(s) 120 via the web interface supported by the web server 116. Similarly, the programmatic client 108 accesses the various services and functions provided by the marketplace system(s) 120 via the programmatic interface provided by the API server 114. The programmatic client 108 may, for example, be a seller application (e.g., the Turbo Lister application developed by eBay® Inc.) to enable sellers to author and manage listings on the networked system 102 in an off-line manner, and to perform batch-mode communications between the programmatic client 108 and the networked system 102.

Additionally, a third party application(s) 128, executing on a third party server(s) 130, is shown as having programmatic access to the networked system 102 via the programmatic interface provided by the API server 114. For example, the third party application(s) 128, utilizing information retrieved from the networked system 102, may support one or more features or functions on a website hosted by the third party. The third party website may, for example, provide one or more promotional, marketplace, or payment functions that are supported by the relevant applications of the networked system 102. The third party server(s) 130 may help facilitate the sale of products related to entertainment media used on client devices 110 and 112 by, for example, displaying advertisements on the client devices 110 and 112 based on information associated with one or more unique user identifiers.

Referring to FIG. 2, a block diagram illustrating a mobile device 200 is presented, according to some example embodiments. The mobile device 200 may be configured to facilitate participation in nested micro-marketplaces, according to at least some example embodiments. The mobile device 200 may be configured to access product listings with multiple prices listed for a single product based on the user's affiliation to one or more micro-marketplaces. The mobile device 200 may also be configured to enter information to set up one or more micro-marketplaces. Application(s) 240 running on the mobile device 200 may utilize the information directed to one or more micro-marketplaces and generate, through a display 250, a product listing reflecting said information. The mobile device 200 may include a processor 210. The processor 210 may be any of a variety of different types of commercially available processors suitable for mobile devices 200 (e.g., an XScale architecture microprocessor, a Microprocessor without Interlocked Pipeline Stages (MIPS) architecture processor, or another type of processor). The processor 210 may be configured to operate application(s) 240 and access information associated with one or more micro-marketplaces. A memory 220, such as a random access memory (RAM), a Flash memory, or other type of memory, is typically accessible to the processor 210. The memory 220 may be adapted to store an operating system (OS) 230, as well as the application(s) 240, such as a mobile application for conducting consumer transactions utilizing information directed to micro-marketplaces. The processor 210 may be coupled, either directly or via appropriate intermediary hardware, to the display 250 and to one or more input/output (I/O) devices 260, such as a keypad, a touch panel sensor, a microphone, a controller, a camera, and the like. Similarly, in some embodiments, the processor 210 may be coupled to a transceiver 270 that interfaces with an antenna 280. The transceiver 270 may be configured to both transmit and receive cellular network signals, wireless data signals, or other types of signals via the antenna 280, depending on the nature of the mobile device 200. In this manner, a connection with a network, such as network 104 of FIG. 1, may be established.

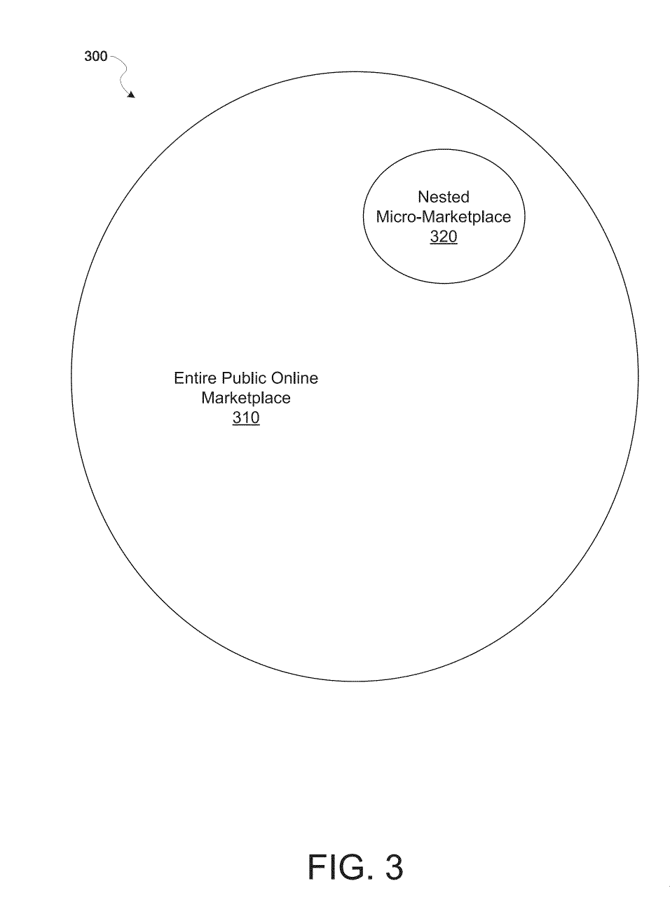

Referring to FIG. 3, diagram 300 illustrates a simple example of a nested micro-marketplace according to some example embodiments. Here, circle 310 can represent an entire public online marketplace. For example, circle 310 can represent all users who have an online account with a website that specializes in online marketplaces, such as Amazon.com, or eBay.com. In other cases, circle 310 simply represents and encompassing number of online users to an online marketplace. The public online marketplace could be managed by the networked system 102. The API server 114, web server 116, application server(s) 118, and database server(s) 124 could facilitate traffic between online merchants and online customers, consistent with the descriptions in FIG. 1. The marketplace system(s) 120 could be configured to generate product listings for merchants in the public online marketplace. In some cases, the merchant can specify information in his product listings through computerized means, such as mobile device 200. In some cases, customers can access the product listings of the public online marketplace through computerized means, such as mobile device 200. In conventional online product listings, the user or merchant selling products online normally cannot make any distinctions to separate potential customers. In other words, a merchant using an online marketplace generally treats all users the same. For example, the merchant generally cannot tell where the potential customers are located, whether they live 2000 miles away or two miles away. If the merchant knew where customers were located, he may be able to give discounts to some customers due to reduced shipping costs. Even if the merchant could tell where potential customers are located, the merchant generally does not have the ability to adjust any prices for potential customers who live closer to him.

However, in some example embodiments, the merchant may be able to designate a subgroup of potential customers out of the global group represented by circle 310, where this subgroup represents a nested micro-marketplace 320. As shown, the smaller oval rests inside the larger circle 310, illustrating diagrammatically how the nested micro-marketplace 320 is a subgroup of the total users represented by circle 310. Furthering the previous example, the nested micro-marketplace 320 could represent all potential customers who have online accounts to the online marketplace and are within nearby ZIP codes of the location of the merchant. As another example, nested micro-marketplace 320 could be a group of individuals who specially identify with the merchant in some particular way. For example, nested micro-marketplace 320 could represent all users of the online marketplace who are alumni of the same college that the merchant graduated from. As another example, nested micro-marketplace 320 could represent users belonging to a common organization or association with the merchant.

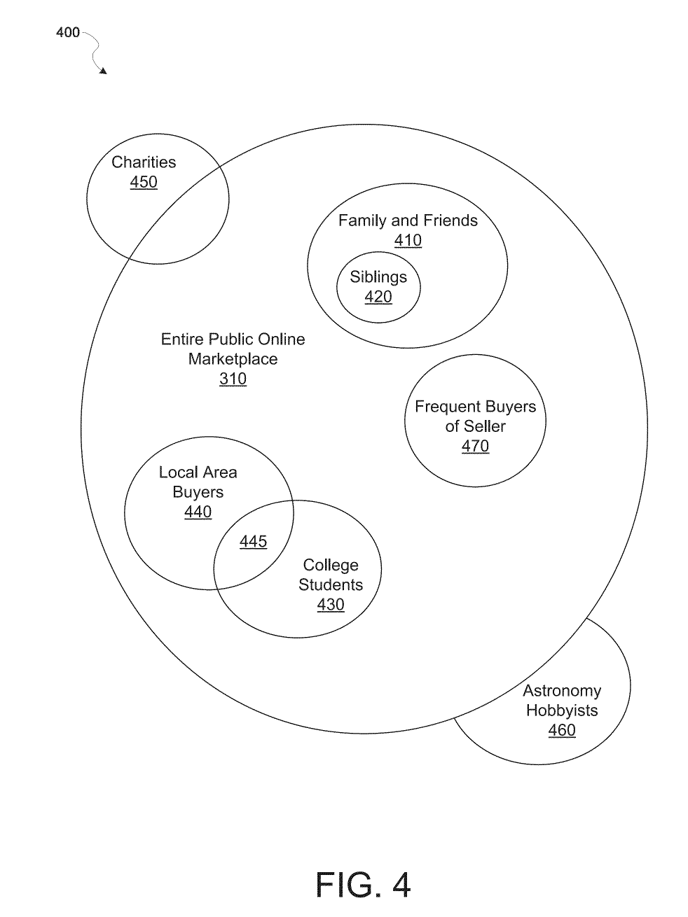

Referring to FIG. 4, diagram 400 illustrates other example micro-marketplaces that may be specified by merchants according to some example embodiments. For example, example embodiments can include nested tiers of micro-marketplaces. The subgroup 410 might represent all users who are designated or listed as friends and family of the merchant. Thus, the friends and family subgroup 410 may represent a nested micro-marketplace within the larger global online marketplace represented by circle 310. In addition, a subgroup 420 within subgroup 410 can represent another micro-marketplace, nested within subgroup 410. In this case, subgroup 420 could represent all siblings of the merchant, which would be a subgroup of the group of friends and family of the merchant.

As another example of nested micro-marketplaces, two subgroups could represent nested micro-marketplaces on their own, but could also have commonality between them to form yet another tier of micro-marketplaces. For example, the subgroup 430 could represent all college students who have an account in the online marketplace. In addition, subgroup 440 could represent all online users who are located within an area local to the location of the merchant. In some cases, some online users may fall within both categories, being both college students and being located within a local area of the merchant. This common region may be represented by the region 445 of the overlapping ovals used to designate subgroups 430 and 440.

Yet another example of nested micro-marketplaces can include a group 450 where some of the users participate in the public online marketplace and where some of the users participate only in a private marketplace, separate from the public marketplace represented by circle 310. The private marketplace could also be online, but it may be private due to, for example, needing a password to participate in the marketplace, or being located in an online marketplace owned by a separate company. As an example, group 450 could represent a consortium of charity organizations, where some members also participate in the public online marketplace represented by circle 310, while others participate only in a website separate from the public online marketplace and specific to the consortium of charity organizations.

In another example of a micro-marketplace, group 460 may represent a group of users where at least some participate in the public online marketplace represented by circle 310, while others do not. However, here, the group 460 has closed itself off to any participation in the public setting, as shown by the group 460 being represented as a circle that is cut off within the public online marketplace circle 310. Thus, the group 460 may represent only a private group participating in an online marketplace. An example private group 460 may include an association of astronomy hobbyists who have signed up to a private chat group online. They may wish for their group only to participate in transactions within themselves. In some cases, the same networked system 102 that manages the online public marketplace can also manage the micro-marketplace of group 460, but the participation of those groups is segregated.

Another type of subgroup the merchant may want to specify as a micro-marketplace is the group 470 of frequent buyers of the merchant. The merchant may wish to identify these users and provide them with special discounts due to establishing a previous relationship with them, rewarding their repeat business, and/or other reasons for recognizing frequent buyers of the merchant.

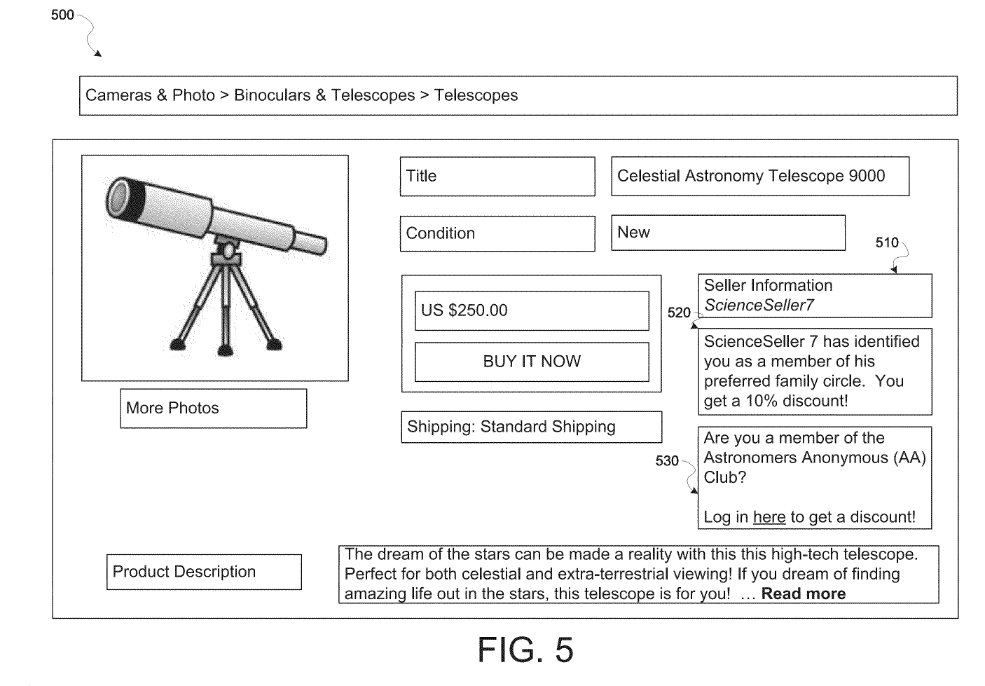

Referring to FIG. 5, example product listing 500 illustrates how one or more micro-marketplaces may be facilitated together with the rest of the online shoppers, according to some example embodiments. In this example, a product listing 500 is presented for a telescope. Product listing 500 shows pieces of information that may be typically found in online product listings, such as the name or title of the product, the condition the product is in, one or more photos, product description, a listed price, a button to enable a shopper to purchase the item, a specification for type of shipping of the item, and an identity of the seller as listed in block 510. In some example embodiments, in addition to conventional information in a product listing, a potential customer viewing the product listing 500 may be shown information indicating whether the potential customer might receive a discount due to being a member of a nested micro-marketplace. For example, the seller, “ScienceSeller7,” listed in block 510, may have entered into an online marketplace system, such as networked system 102, a number of user accounts that seller ScienceSeller7 identifies as belonging to some of his family members. ScienceSeller7 may have specified this information on a separate screen generated by marketplace system(s) 120 and saved into database(s) 126, for example. In this way, all users listed in this group may represent one nested micro-marketplace specified by seller ScienceSeller7. After this information may have been entered, a potential customer having an account ID belonging to the list of ScienceSeller7's family members may peruse the product listings in the online marketplace system and come across product listing 500. Upon seeing that product listing 500 has been posted by seller ScienceSeller7, the networked system 102 may display to the user the text in box 520, which reads, “ScienceSeller7 has identified you as a member of his preferred family circle. You get a 10% discount!” The seller ScienceSeller7 may have also specified that whenever one of his family members considers buying one of his products, the family member may receive some discount off the listed price, which in this case is 10% off. Certainly, other kinds of discounts could be possible, including discounts off of shipping, coupons to other products by the same seller, offers for packaged deals where the total cost is less than the sum of the individual products, or other kinds of discounts apparent to those with skill in the art. The networked system 102 may receive these inputs from the seller, rather than have any of these inputs—including the types of groupings of micro-marketplaces and what benefits they may receive—be dictated by supply and demand or other free market forces.

In another example, seller ScienceSeller7 may have also specified second nested micro-marketplace for members of the “Astronomers Anonymous (AA) Club.” Being a member of the AA Club himself, ScienceSeller7 may have asked from members of the AA Club their account IDs to the online marketplace. ScienceSeller7 may have obtained these through conventional means, such as the members responding to him over email or the members writing their IDs on a signup sheet. ScienceSeller7 may have then entered into networked system 102 all the account IDs of all members of the AA Club who gave him their information, specifying this set of account IDs as being part of a micro-marketplace for the AA Club. In other cases, ScienceSeller7 may have created, via networked system 102, a micro-marketplace for the AA Club with a password, such that anybody who simply knows the password would be considered part of the micro-marketplace of the AA Club. ScienceSeller7 may have shared the password with the AA Club through a separate communication, such as in an email group, a social media page, or in person in a meeting of the AA Club. Thus, when a member of the AA Club shops for products in the online marketplace and sees product listing 500, the shopper can respond to a box 530 that reads, “Are you a member of the Astronomers Anonymous (AA) Club? Log in here to get a discount!” A hyperlink to a login page may be linked to the word “here,” allowing a shopper to enter a password or other information in order to obtain a discount. The member of the AA Club would know or have access to the password to access the discount, based on the member's affiliation and interactions with seller ScienceSeller7. In some cases, box 530 may be displayed for any and all users who view product listing 500, but only those who are members of the AA Club would be able to utilize box 530 due to actually being affiliated with the AA Club.

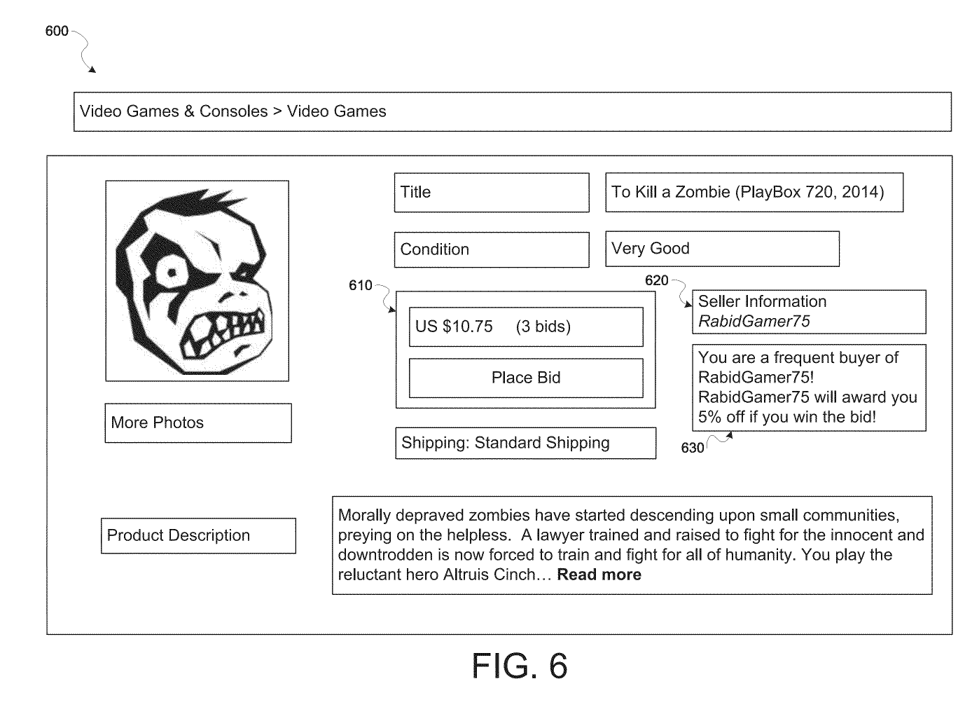

Referring to FIG. 6, example product listing 600 illustrates how nested micro-marketplaces can be utilized in other marketplace settings, such as in the auction context. Here, example product listing 600 shows a videogame for sale, with similar information to FIG. 5 shown. However, instead of a purchase price shown, box 610 displays an auction price with the highest current bid and a button to place a bid in an attempt to win the bid for the videogame. In this case, the seller “RabidGamer75,” as shown in box 620, may offer discounts to users within one or more nested micro-marketplaces when one of those members wins the bid. As an example, RabidGamer75 may have chosen to offer a discount to shoppers who have purchased products from him multiple times in the past. For example, RabidGamer75 may consider anybody who has purchased products from him more than three times to be a “frequent buyer.” RabidGamer75 may have entered into networked system 102 this definition of a frequent buyer. RabidGamer75 may have entered this information via a computer device connected to networked system 102, such as through mobile device 200 or client devices 110 or 112. The networked system 102 may store this information in database(s) 126 as part of RabidGamer75's user profile, as an example. Networked system 102 may be configured to collect statistics on what products users may purchase, from whom the users may purchase from, and other marketing information apparent to those with skill in the art. Thus, based on RabidGamer75's specifications of what constitutes a frequent buyer, if a user of the online public marketplace qualifies as a frequent buyer according to RabidGamer75's specifications and the user sees a product listing 600 offered by RabidGamer75, the user may then also see displayed a box 630 that reads, “You are a frequent buyer of RabidGamer75! RabidGamer75 will award you 5% off if you win the bid!” Other kinds of benefits could be offered to users found to be within one or more nested micro-marketplaces specified by the seller, according to some example embodiments. For example, a user winning the bid and being a part of a nested micro-marketplace could be offered free shipping, discounted shipping, coupons or rebates to a product the user may later buy from the seller, some free merchandise, or other kinds of benefits apparent to those with skill in the art.

Systems and apparatuses according to aspects of the present disclosure may facilitate other kinds of nested micro-marketplaces, according to some example embodiments. For example, networked system 102 may be configured to monitor traffic across the network sufficient to determine an approximate location of online shoppers. For example, networked system 102 may be configured to monitor and record the IP addresses of online shoppers, where each IP address corresponds to some known approximate location. In this way, networked system 102 may be able to help facilitate and determine whether the online shopper lives near the seller, and if so, may be configured to inform the online shopper that she can receive a discount if she purchases an item from the seller located near her. As another example, a college or university campus may have a predetermined band of IP addresses, such that networked system 102 can determine if the online shopper is located on the college or university campus. The seller may also be a member of the college or university, and may have specified a nested micro-marketplace to be all members of her college or university. Thus, networked system 102 can determine if the online shopper is a member of the seller's college or university, and if so, inform the online shopper that she could receive a discount from the seller who also lives on the same college or university campus.

In some example embodiments, the designations of nested micro-marketplaces can allow the seller to offer a single item for sale in multiple temporal stages through the online marketplace. For example the seller may first place a product listing for a camera available only to members within one or more of his designated micro-marketplaces. For example, he may place the product listing of the camera viewable only to his friends and family micro-marketplace, and may offer a 20% discount from the average price listed for similar types of cameras, the average price based on his observations of other product listings in the online marketplace. If he receives no offers to purchase the camera from this first nested micro-marketplace, after some period of time, the seller may open the product listing to one or more other micro-marketplaces, and may offer just a 10% discount from the average price. If the seller receives no offers to purchase the camera from this wider audience, after some period of time, the seller may then decide to open the product listing to the entire online public marketplace, at full price.

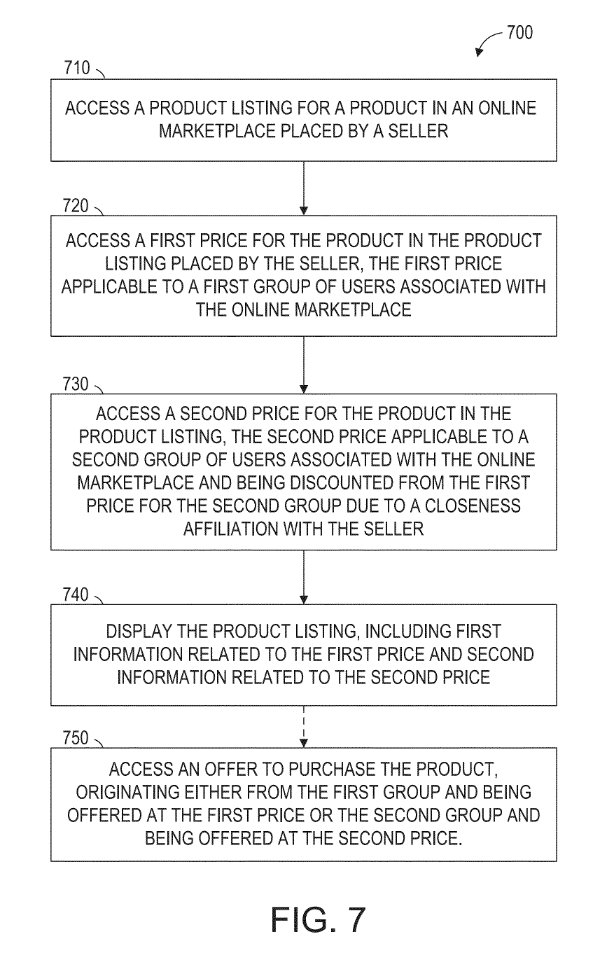

Referring to FIG. 7, the flowchart illustrates an example methodology 700 for facilitating nested micro-marketplaces in an online marketplace, according to aspects of the present disclosure. The example methodology 700 may be performed by a system of an online marketplace residing on a server, such as networked system 102. Any information or data described in the example methodology 700 may be stored in a memory of the online marketplace, such as in database(s) 126. The example methodology may be consistent with the methods described herein, including, for example, the descriptions in FIGS. 1, 2, 3, 4, 5, and 6.

At block 710, the online marketplace system may access a product listing placed by a seller for a product. Example product listings can include example listings described in FIGS. 5 and 6, as well as other types of product listings apparent to those with skill in the art. In some example embodiments, the online marketplace system may access the product listing from a device controlled by the seller, such as mobile device 200 or client devices 110 and 112. The online marketplace system may be in communication with the device controlled by the seller through a network, such as network 104.

At block 720, the online marketplace system may access a first price for the product in the product listing placed by the seller, the first price applicable to a first group of users associated with the online marketplace. In some example embodiments, the first price may be specified by the seller through the device controlled by the seller and accessible to the online marketplace system through the network. In some example embodiments, the first group may represent the entire public online marketplace associated with the online marketplace system. In this case, the first price may be the full, undiscounted price that the seller intends to sell the product at. In some example embodiments, the first group may represent a nested micro-marketplace of a global online marketplace, the description of which may be consistent with any of the descriptions within the present disclosure.

At block 730, the online marketplace system may access a second price for the product in the product listing, the second price being applicable to a second group of users associated with the online marketplace and being discounted from the first price for the second group due to a closeness affiliation with the seller. In some example embodiments, the second price may also be specified by the seller through the device controlled by the seller and accessible to the online marketplace system through the network. In some example embodiments, the online marketplace system may access prices associated with the second group based on information specified by the seller through the device controlled by the seller and accessed through the network. In some example embodiments, the second group may represent a nested micro-marketplace within the first group. In some example embodiments, the seller may have a closeness affiliation with the second group, such as considering the second group among friends and family, being an affiliated member of the second group, living nearby all members and the second group, and so on. In some example embodiments the discounted price for the second group may be represented in a number of ways, including a fixed amount off the purchase price, percentage off the purchase price, a rebate or coupon for discount to later product, or a discounted price to a package of products including the product listed in this product listing.

At block 740, the online marketplace system may display the product listing, the product listing including first information related to the first price and second information related to the second price. In some example embodiments, the product listing may be displayed by the online marketplace system through one or more processors, such as a processor residing in marketplace system(s) 120, and transmitted to a display screen of the online marketplace system or to a separate display screen through network 104. In some example embodiments, the first information related to the first price may include a listing of the first price with a description of who the first price is applicable to. In some example embodiments the second information related to the second price may include a listing of the second price with a description of who the second price is applicable to. Other examples of first and second information may be consistent with example product listings in FIGS. 5 and 6, as well as any other information consistent with the present disclosure and apparent to those with skill in the art.

At block 750, optionally, the online marketplace system may access an offer to purchase the product, the offer originating either from a first user associated with the first group and being offered at the first price, or a second user associated with the second group and being offered at the second price. The offer to purchase the product may be accessed from information originating at a device controlled by either the first user or the second user, such as client devices 110 or 112, or mobile device 200.

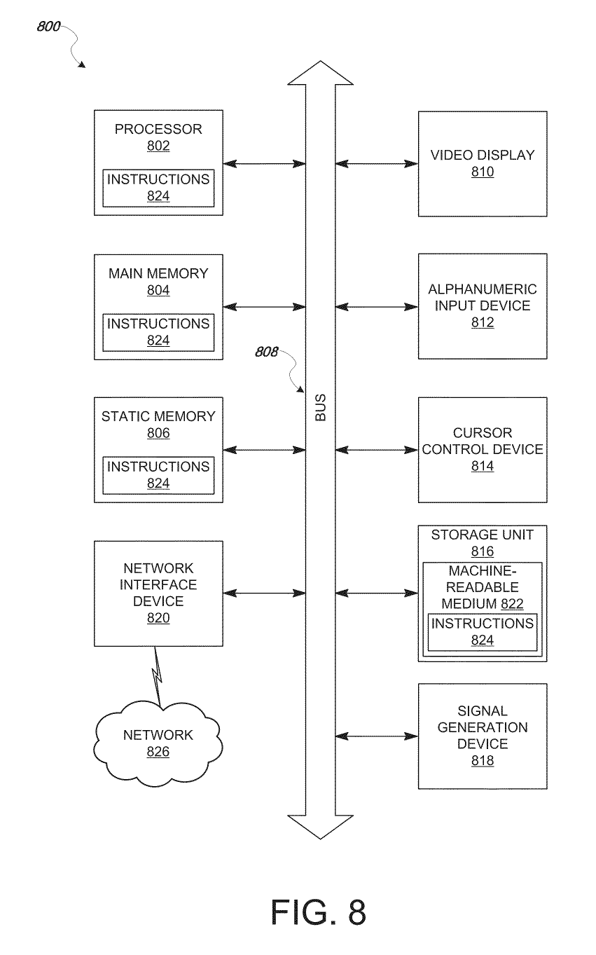

Referring to FIG. 8, the block diagram illustrates components of a machine 800, according to some example embodiments, able to read instructions 824 from a machine-readable medium 822 (e.g., a non-transitory machine-readable medium, a machine-readable storage medium, a computer-readable storage medium, or any suitable combination thereof) and perform any one or more of the methodologies discussed herein, in whole or in part. Specifically, FIG. 8 shows the machine 800 in the example form of a computer system (e.g., a computer) within which the instructions 824 (e.g., software, a program, an application 240, an applet, an app, or other executable code) for causing the machine 800 to perform any one or more of the methodologies discussed herein may be executed, in whole or in part.

In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a distributed (e.g., peer-to-peer) network environment. The machine 800 may include hardware, software, or combinations thereof, and may as examples be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 824, sequentially or otherwise, that specify actions to be taken by that machine. Further, while only a single machine 800 is illustrated, the term “machine” shall also be taken to include any collection of machines 800 that individually or jointly execute the instructions 824 to perform all or part of any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824, such that the processor 802 is configurable to perform any one or more of the methodologies described herein, in whole or in part. For example, a set of one or more microcircuits of the processor 802 may be configurable to execute one or more modules (e.g., software modules) described herein.

The machine 800 may further include a video display 810 (e.g., a plasma display panel (PDP), a light emitting diode (LED) display, a liquid crystal display (LCD), a projector, a cathode ray tube (CRT), or any other display capable of displaying graphics or video). The machine 800 may also include an alphanumeric input device 812 (e.g., a keyboard or keypad), a cursor control device 814 (e.g., a mouse, a touchpad, a trackball, a joystick, a motion sensor, an eye tracking device, or other pointing instrument), a storage unit 816, a signal generation device 818 (e.g., a sound card, an amplifier, a speaker, a headphone jack, or any suitable combination thereof), and a network interface device 820.

The storage unit 816 includes the machine-readable medium 822 (e.g., a tangible and non-transitory machine-readable storage medium) on which are stored the instructions 824 embodying any one or more of the methodologies or functions described herein, including, for example, any of the descriptions of FIGS. 1, 2, 3, 4, 5, 6, and/or 7. The instructions 824 may also reside, completely or at least partially, within the main memory 804, within the processor 802 (e.g., within the processor's cache memory), or both, before or during execution thereof by the machine 800. The instructions 824 may also reside in the static memory 806.

Accordingly, the main memory 804 and the processor 802 may be considered machine-readable media 822 (e.g., tangible and non-transitory machine-readable media). The instructions 824 may be transmitted or received over a network 826 via the network interface device 820. For example, the network interface device 820 may communicate the instructions 824 using any one or more transfer protocols (e.g., Hypertext Transfer Protocol (HTTP)). The machine 800 may also represent example means for performing any of the functions described herein, including the processes described in FIGS. 1, 2, 3, 4, 5, 6, and/or 7.

In some example embodiments, the machine 800 may be a portable computing device, such as a smart phone or tablet computer, and have one or more additional input components (e.g., sensors or gauges), not shown. Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 822 able to store data temporarily or permanently and may be taken to include, but not be limited to, RAM, read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions 824. The term “machine-readable medium” shall also be taken to include any medium, or combination of multiple media, that is capable of storing the instructions 824 for execution by the machine 800, such that the instructions 824, when executed by one or more processors of the machine 800 (e.g., processor 802), cause the machine 800 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 822 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors 802) may be configured by software (e.g., an application 140 or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 802 or other programmable processor 802. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 802 configured by software to become a special-purpose processor, the general-purpose processor 802 may be configured as respectively different special-purpose processors (e.g., comprising different hardware modules) at different times. Software (e.g., a software module) may accordingly configure one or more processors 802, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions described herein. As used herein, “processor-implemented module” refers to a hardware module implemented using one or more processors 802.

Similarly, the methods described herein may be at least partially processor-implemented, the processor 802 being an example of hardware. For example, at least some of the operations of a method may be performed by one or more processors 802 or processor-implemented modules. As used herein, “processor-implemented module” refers to a hardware module in which the hardware includes one or more processors 802. Moreover, the one or more processors 802 may also operate to support performance of the relevant operations in a “cloud computing” environment or as a “software as a service” (SaaS). For example, at least some of the operations may be performed by a group of computers (as examples of machines 800 including processors), with these operations being accessible via a network 826 (e.g., the Internet) and via one or more appropriate interfaces (e.g., an application program interface (API)).

The performance of certain operations may be distributed among the one or more processors 802, not only residing within a single machine 800, but deployed across a number of machines 800. In some example embodiments, the one or more processors 802 or processor-implemented modules may be located in a single geographic location (e.g., within a home environment, an office environment, or a server farm). In other example embodiments, the one or more processors 802 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by the machine 800. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of the machine 800 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions define various example embodiments of methods, machine-readable media, and systems (e.g., apparatus) discussed herein:

1. A computer implemented method comprising:

accessing, in an online marketplace, a product listing for a product in the online marketplace placed by a seller,
accessing a first price for the product in the product listing placed by the seller, the first price applicable to a first group of users associated with the online marketplace;
accessing a second price for the product in the product listing placed by the seller, the second price applicable to a second group of users associated with the online marketplace and being discounted from the first price for the second group due to a closeness affiliation with the seller of the product;
displaying the product listing of the product, the product listing including first information related to the first price and second information related to the second price; and
accessing an offer to purchase the product, based on the displayed product listing, the offer either originating from a first buyer in the first group and being offered at the first price, or originating from a second buyer in the second group and being offered at the second price.

2. The method of description 1, wherein the second group comprises a nested micro-marketplace group that is a subset of the users of the first group.

3. The method of description 2, wherein the first group comprises a second nested micro-marketplace group that is a subset of users of a global group of users associated with the online marketplace.

4. The method of description 1, wherein the discount associated with the second price comprises a coupon or rebate to purchase a second product from the seller at a reduced price.

5. The method of description 1, wherein the closeness affiliation with the seller comprises a frequent buyer designation specified by the seller.

6. The method of description 1, wherein the closeness affiliation with the seller comprises information to determine that the users in the second group belong to an organization in common with the seller.

7. The method of description 1, wherein the offer to purchase the product comprises a bid for the product in an online auction context.

8. An apparatus comprising an input interface, an output interface, and at least one processor configured to perform any of the descriptions in descriptions 1 through 7.

9. A computer-readable medium embodying instructions that, when executed by a processor, perform operations comprising any of the descriptions in descriptions 1 through 7.

10. An apparatus comprising means for performing any of the descriptions in descriptions 1 through 7.

What is claimed is:

1. A method comprising:
accessing, in an online marketplace, a product listing for a product in the online marketplace placed by a seller;
accessing a first price for the product in the product listing placed by the seller, the first price applicable to a first group of users associated with the online marketplace;
determining that a buyer of the product is within a second group;
accessing a second price for the product in the product listing placed by the seller, the second price applicable to a second group of users associated with the online marketplace and being discounted from the first price for the second group due to a closeness affiliation with the seller of the product; and
displaying the product listing of the product to the buyer, the product listing including first information related to the first price and second information related to the second price.

2. The method of claim 1, wherein the second group comprises a nested micro-marketplace group that is a subset of the users of the first group.

3. The method of claim 2, wherein the first group comprises a second nested micro-marketplace group that is a subset of users of a global group of users associated with the online marketplace.

4. The method of claim 1, wherein the discount associated with the second price comprises a coupon or rebate to purchase a second product from the seller at a reduced price.

5. The method of claim 1, wherein the closeness affiliation with the seller comprises a frequent buyer designation specified by the seller.

6. The method of claim 1, wherein the closeness affiliation with the seller comprises information to determine that the users in the second group belong to an organization in common with the seller.

7. The method of claim 1, wherein the offer to purchase the product comprises a bid for the product in an online auction context.

8. A system comprising:
a memory; and
a processor coupled to the memory and configured to:
access, in an online marketplace, a product listing for a product in the online marketplace placed by a seller;
access a first price for the product in the product listing placed by the seller, the first price applicable to a first group of users associated with the online marketplace;
access a second price for the product in the product listing placed by the seller, the second price applicable to a second group of users associated with the online marketplace and being discounted from the first price for the second group due to a closeness affiliation with the seller of the product;
display the product listing of the product in a display device, the product listing including first information related to the first price and second information related to the second price; and
access an offer to purchase the product, based on the displayed product listing, the offer either originating from a first buyer in the first group and being offered at the first price, or originating from a second buyer in the second group and being offered at the second price.

9. The system of claim 8, wherein the second group comprises a nested micro-marketplace group that is a subset of the users of the first group.

10. The system of claim 9, wherein the first group comprises a second nested micro-marketplace group that is a subset of users of a global group of users associated with the online marketplace.

11. The system of claim 8, wherein the discount associated with the second price comprises a coupon or rebate to purchase a second product from the seller at a reduced price.

12. The system of claim 8, wherein the closeness affiliation with the seller comprises a frequent buyer designation specified by the seller.

13. The system of claim 8, wherein the closeness affiliation with the seller comprises information to determine that the users in the second group belong to an organization in common with the seller.

14. The system of claim 8, wherein the offer to purchase the product comprises a bid for the product in an online auction context.

15. A computer-readable medium embodying instructions that, when executed by a processor, perform operations comprising:
accessing a product listing for a product in an online marketplace placed by a seller;
accessing a first price for the product in the product listing placed by the seller, the first price applicable to a first group of users associated with the online marketplace;
accessing a second price for the product in the product listing placed by the seller, the second price applicable to a second group of users associated with the online marketplace and being discounted from the first price for the second group due to a closeness affiliation with the seller of the product;
displaying the product listing of the product, the product listing including first information related to the first price and second information related to the second price; and
accessing an offer to purchase the product, based on the displayed product listing, the offer either originating from a first buyer in the first group and being offered at the first price, or originating from a second buyer in the second group and being offered at the second price.

16. The computer-readable medium of claim 15, wherein the second group comprises a nested micro-marketplace group that is a subset of the users of the first group.

17. The computer-readable medium of claim 16, wherein the first group comprises a second nested micro-marketplace group that is a subset of users of a global group of users associated with the online marketplace.

18. The computer-readable medium of claim 15, wherein the discount associated with the second price comprises a coupon or rebate to purchase a second product from the seller at a reduced price.

19. The computer-readable medium of claim 15, wherein the closeness affiliation with the seller comprises a frequent buyer designation specified by the seller.

20. The computer-readable medium of claim 15, wherein the closeness affiliation with the seller comprises information to determine that the users in the second group belong to an organization in common with the seller.
